(19) United States
(12) Patent Application Publication
(10) Pub. No.: US 2002/0045103 A1
(43) Pub. Date: Apr. 18, 2002

(54) Reduction of feature size using photosensitive polymers

(75) Inventors: Anthony S. Kewitsch, Hacienda Heights, CA (US); Amnon Yariv, San Marino, CA (US)

Correspondence Address: SCOTT C. HARRIS, Fish & Richardson P.C., Suite 500, 4350 La Jolla Village Drive, San Diego, CA, 92122, US

(73) Assignee: California Institute of Technology

(21) Appl. No.: 09/941,368

(22) Filed: Aug. 28, 2001

Related U.S. Application Data
(63) Continuation of application No. 08/741,267, filed on Oct. 30, 1996.
(60) Provisional application No. 60/006,084, filed on Oct. 31, 1995.

(51) Int. Cl. G03H 1/22; G02B 5/32

(52) U.S. Cl. 430/1; 430/2; 359/15; 430/5

(57) ABSTRACT

Polymer techniques are used to reduce the feature size in electrical or mechanical processes. A first embodiment uses a light sensitive polymer. A first illumination forms a lens structure. A second illumination is focused by that lens structure to form a final feature. The lens can then be removed. A second embodiment uses holographic techniques to pattern polymers and form consistent pores within the polymers.

### FIELD OF THE INVENTION

The present invention describes structure and techniques that are used to reduce the feature size that is produced in a final product.

### BACKGROUND AND SUMMARY

Many polymers are physically changed when radiation is applied to the polymer. For example, the optical index of refraction of some polymers change when they are exposed to optical radiation, for example, light. The usual index of refraction change of this type is called photopolymerization, and these materials are usually called photopolymers.

Miniaturization of feature size is a desired effect in many different kinds of technologies. Semiconductor integrated circuits can be made smaller through minimized feature size. This is an example of an electrical technology that requires minimized feature size. The storage capacity of memory devices can be increased by storing each bit of information in a smaller, more closely spaced memory location, for example. Mechanical technology also often benefits from reduced feature size. For example, many porous substances may benefit from smaller sized pores. Reduction of feature size thus finds application in many different technologies.

Our previous patent application PCT 96/10151 describes a change in index of refraction of a polymer that tends to contain the optical radiation that causes the index change. The inventors have labelled this effect as self trapping and self-focusing. This specification is herewith incorporated by reference, and many of the materials and techniques that are described in this specification are usable with the present invention.

The inventors of the present invention have recognized that a special operation could be carried out in a photopolymer in a way to produce a device that approximates a lens effect, to further focus incoming optical radiation. That intermediate lens structure is used to further focus the incoming radiation. The intermediate structure may then be removed.

According to this aspect of the present invention, index changes in photopolymers are caused by incoming radiation, e.g., optical radiation. For example, incoming light may crosslink the polymer, or in some way change it in a way that can allow selective removal of parts of the polymer layer based on the shape of the incoming light.

The removal uses a stripper. In the prior art, that stripper has tended to remove in an even fashion, i.e., to smooth the surface as it removes the material. Many different kinds of wet strippers are suitable for this kind of operation.

According to the present invention, features are formed, such as lenses or lens-like features. Those lens-like features tend to further focus the light in order to further minimize the size of the features.

Feature size is also important when forming porous polymers—polymers which include orifices or pores therein. Porous polymers have often been made by exposing a polymer to gamma radiation in order to intentionally damage the physical structure of the polymer. This leaves damage to the polymer in the form of random holes in the polymer area. Those holes may mix and cross at various locations. As the name implies, the hole structure and formation is entirely random. The present invention teaches a special technique which forms an ordered porous structure in the polymer.

### BRIEF DESCRIPTION OF THE DRAWINGS

These and other aspects of the invention will now be described in detail with reference to the accompanying drawings, wherein:

FIGS. 1-4 show a first embodiment of the present invention in which FIG. 1 shows an initial exposure stage,

FIG. 2 shows an interim stage,

FIG. 3 shows a secondary exposure stage, and

FIG. 4 shows a final result; and

FIGS. 5A-5D show example interference patterns between plane waves used, for example, to form porous polymers.

### DESCRIPTION OF THE PREFERRED EMBODIMENT

It should be understood that all polymers referred to herein have a characteristic wherein some kind of radiation that is applied to the polymer changes some characteristic of the polymer which enables altering the polymer according to that characteristic.

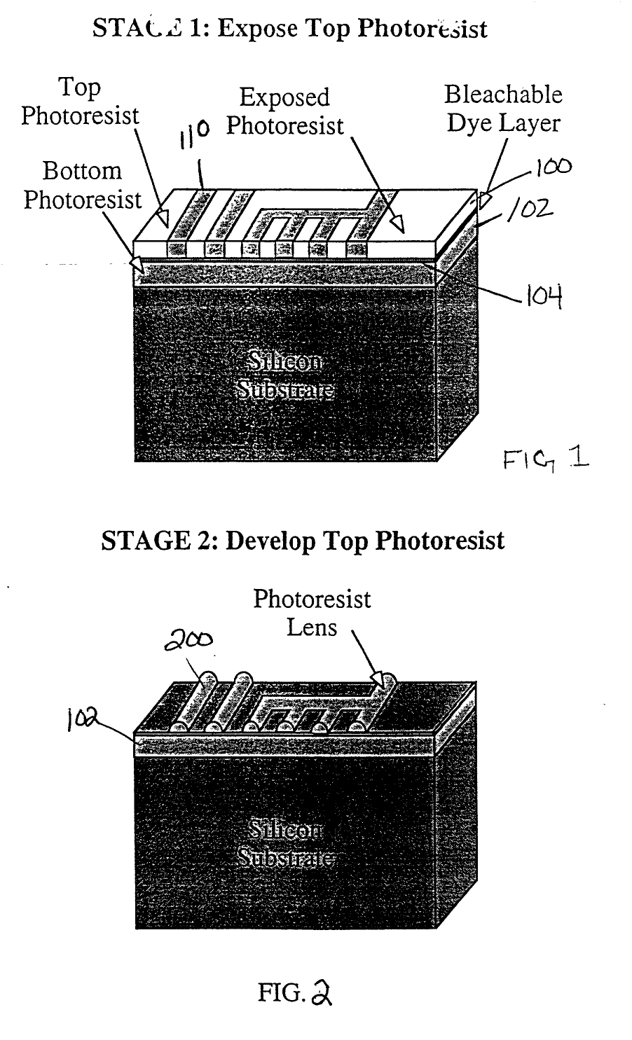

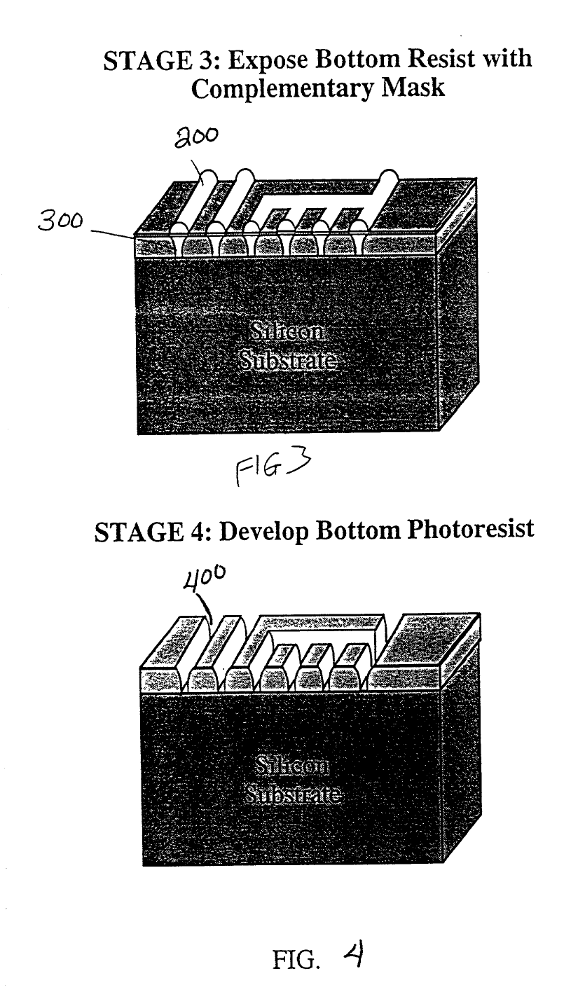

A first embodiment of the invention is illustrated in FIGS. 1 and 2. This embodiment reduces the feature size that is attainable for a given wavelength and optical projection system by using an interim exposure device.

Lens-shaped surface relief patterns are impressed on standard photoresists. Those standard photoresists then act as focusing lenses to focus that light to another part of the polymer. This even further minimize the feature sizes of that latter exposure.

FIGS. 1 and 2 show the processing steps of the present invention. The photoresists 100, 102 shown in FIGS. 1 and 2 are of the “positive” type, i.e. they form a positive projection mask and its complement. The photoresists 100, 102 may be separated by a layer of photobleachable dye 104, such as used in standard contrast enhancement layers. Alternately, the photoresist 100 itself may be photobleachable.

FIG. 1 shows a first step in which a standard positive mask 110 is projected onto the top photoresist 100. The preferred embodiment of this invention uses 248 nm illumination. This translates to a minimum feature size of 0.25 μm for an optical projection system having a numeric aperture of 0.5. The exposure increases the solubility of the positive photoresist in some etchant compound, usually an isotropic compound. The solubility of the unexposed positive resist remains the same. Hence, exposure to the etchant preferentially etches the exposed areas.

FIG. 2 shows the result after the top photoresist has been etched with a standard isotropic agent. The isotropic agents tend to round the corners of the photoresist profile. The rounded features exhibit a quadratic profile. The quadratic profile is selected to focus the incident light, thus producing a lens-like resist pattern that is a replica of the original mask. The etched-lens profile must be sufficiently smooth to avoid undesirable light scattering.

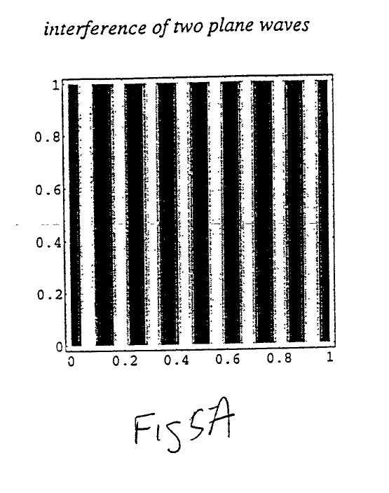

This initial exposure leaves the first result as a complementary mask. The bottom photoresist is now exposed with a mask that is complementary, i.e., the negative, of the mask of stage 1. The light pattern passes through the lens-like profile 200 in the top photoresist and is focused into the bottom photoresist 102 as shown in FIG. 3. The focusing into the bottom photoresist forms secondary features 300. These secondary features are preferably smaller in size than the smallest possible feature availible from the original exposure.

The first-formed lens 200 is an intimate part of the photoresist, having an index of refraction of about 1.5. The numerical aperture of the imaging system is increased by approximately a factor of the photoresist index of refraction, which is typically 1.5.

Use of this kind of device may enable a drastic decrease of the minimum feature size that can be imaged from 0.25 microns to about 0.165 microns.

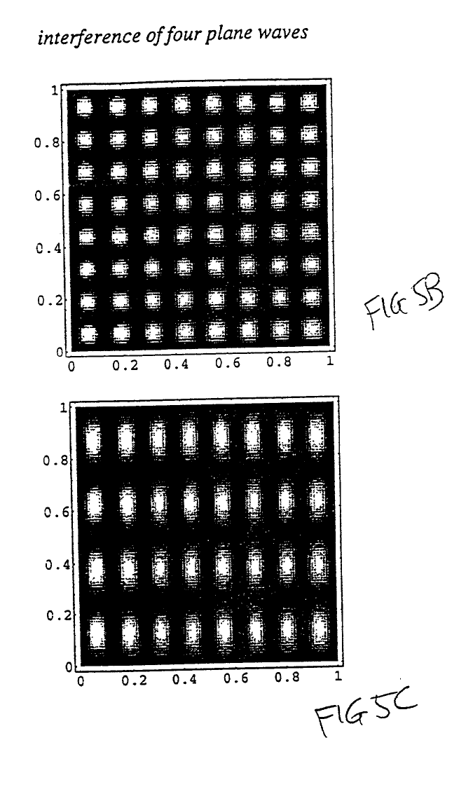

The final finished photoresist is shown in FIG. 4. All remaining exposed portions i.e., all lens portions 200 and all exposed portions of the photoresist, are stripped. This leaves a final resist profile 400 with trenches whose feature size exceeds the resolution limit of the stepper.

It should be understood that features other than lenses can be used, and that the advatageous results of the present invention can be obtained by any process which uses radiation to form an initial structure that further contains the radiation to form a reduced-size feature. Of course, more than one interim developing step could be used.

Another application in which feature size is extremely important is in porous polymer materials. Porous polymer materials are used in contact lenses, artificial skin, bones, and corneas, micro-pore filters, pharmokinetic systems, porous membranes for chemical separation, light-weight structural materials, shock-absorbent materials and certain clothing. A porous polymer often breathes much like human skin. Porous polymers have also been used in other unrelated structures, such as phototonic band gap structures or micromachined heat exchangers.

Several techniques are known to fabricate porous polymers from liquid precursors. Some of the recent patents showing this include U.S. Pat. Nos. 5,358,974; 5,349,155; 5,328,613; 5,306,632; 5,306,311; 5,273,657; 5,229,045; 5,186,835; 5,183,607; 5,162,939; 5,160,529; 5,147,401; 4,753,717; 4,742,086; 4,099,218; and 3,969,562. Many of these techniques form random pores in the structure.

The inventors, however, have noticed that certain special advantages would be obtained by obtaining more regular pores in the polymer structure. For example, the random pores are statistically randomly distributed. This means, however, that the local distribution can be irregular. Moreover, the shapes and sizes of the pores can vary greatly. The inventors realized that there could be special advantages in an application for highly precise and regular porous polymers.

This is done according to this embodiment by using a liquid photopolymer which is crosslinked by illumination with suitable radiation, e.g., ultraviolet radiation. According to the present invention, two or more radiation beams interfere to form radiation standing waves. These standing waves are preferably optical, and preferably produce a spatial pattern that has light and dark regions.

A liquid photopolymer, preferably of a type which does not allow light scattering in the liquid, is used. The radiation standing waves form an interference pattern that has a gaussian profile, and hence is substantially constant across the entire depth liquid photopolymer. Conventional techniques are used to expose the photopolymer, and thereafter sculpt the photopolymer to the optical pattern into a structural pattern that depends on the optical pattern. These structural patterns hence form pores in the polymer.

An important recognition of the present invention is the use of holographic techniques to carry out this patterning. The inventors noticed that if regular illumination was used, the image would be in focus only at a particular portion of the polymer. Diffraction would cause spreading of the image at areas other than that focal plane. Hence, this image would smear out beyond that focal plane.

Holographic techniques, in contrast, do not smear over time, and hence allow significant flexibility in the size, shape and depth of the pores. This allows formation of a pore of a desired shape and depth over the entire area of the pore.

A liquid photopolymer is preferably exposed at 1 mw/cm² intensity, for 1 to 50 seconds continuously. The exposure itself is an optical interference pattern, formed by interfering two or more beams to produce a grating with a period of 200 μm to produce pores that are 100 μm in diameter, and of any desired shape. The holographic technique can be implemented, for example, by using a phase mask which divides a single plane wave into several diffraction orders, which interfere in a holographic manner.

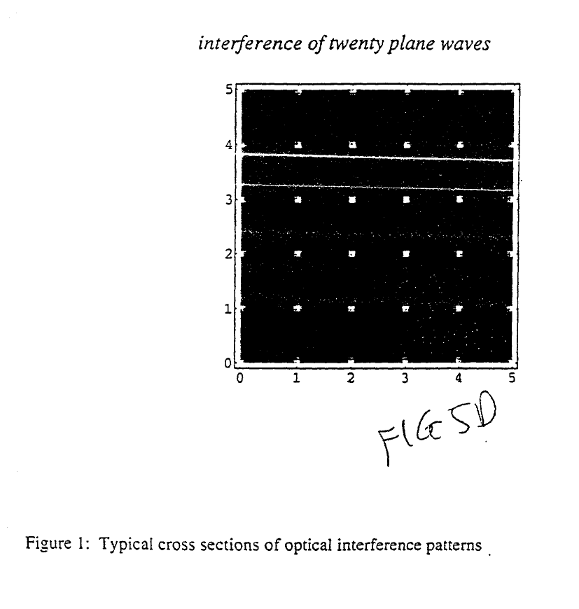

FIGS. 5A-5D show representative cross section of interference patterns formed by interfering plane waves. FIG. 5A shows an interference between two plane waves; FIGS. 5B and 5C show an interference between four plane waves, and FIG. 5D shows an interference between 20 plane waves. These patterns are of course merely illustrative, and it should be understood that many other such devices could be used. These or other holographic patterns will remain unchanged as a function of propagation distance throughout the entire thickness of the polymers. Both thick polymers and thin polymers can be patterned in this way.

This special pore formation technique provides a significant advantage over projection photolithography in which only a restricted depth of focus of thin polymers can be patterned. The present invention allows use with thick samples which may allow large pressure differentials over a filter made with the materials.

The typical feature size of the holographic pattern is limited by Bragg's law as follows:

$$d = \frac{λ}{2 n sin Θ}$$

Where λ is the half angle of the pair of interfering beams of largest half angle, λ is their wavelength and n is the index of the refraction of the photopolymer. For counterpropagating beams from a HeCd laser at 325 nm, the minimum feature size becomes about 50 nm. The feature sizes, however, can range as high as 100 μm.

The present techniques allow any desired pore shape to be designed in many different ways according to the present invention. A particularly preferred technique, Fourier synthesizes an interference pattern from a sum of sinusoidal gratings. This allows molecules of a particular size and shape to pass preferentially through the polymer membrane. For example, holes with prolate ellipsoid cross sections may allow linear molecules to pass while blocking spherical molecules.

The preferred technique begins with uncured polymer, and cures a portion of that polymer using radiation patterns. The uncured polymer is typically drained following exposure. The preferred draining process uses a polymer of sufficiently low viscosity that removes the liquid from the microscopic pores. A combination of solvents in addition to vacuum heating can assist in evaporating these liquids.

The above two embodiments have described positive processes, which use the incoming radiation to cure a liquid photopolymer. A negative process can be used with either of these two embodiments. A negative process starts with a cured polymer, and uses radiation, e.g., UV light, to break certain bonds along the polymer backbone. This dissolves rather than curing/crosslinking the material in the illuminated regions. This technique has been used in micro-electronic photoresists. This is essentially a subtractive process which produces structures that are complementary to the additive or negative process.

This negative process may be less susceptible to shrinkage and index change on illumination. More importantly, positive photoresists exhibit high spatial resolution, e.g., less than 100 nm, because of absence of diffusion of the photogenerated radicals.

### EXAMPLE 1: NEGATIVE PROCESS

Typical negative photoresists in which crosslinking occurs in the illuminated regions include the methacrylates, acrylates, and epoxy resins. The typical formulation should have sufficiently low viscosity in the liquid form that the monomer can be removed from unilluminated regions. Typically, the dark regions will be microscopic pores and through holes. Surface tension will be the dominant force preventing the removal of uncured liquid polymer from these regions. Suitable solvents to assist in the removal of this material includes acetone, TPM and isopropyl alcohol. The liquid polymer may also be evaporated by heating and/or placing in a vacuum.

The concentration of the photoinitiator is selected so that the penetration depth is of the order of the thickness of the sample to be cured. This reduces the gradient of the intensity pattern as it propagates through the thickness of the material. A typical composition for a 5 mm thick sample is a two part photopolymer consisting of HDODA (from UCB Radcure, Inc.) and 0.005 weight percent Irgacure 369 (from Ciba-Geigy).

### EXAMPLE 2: NEGATIVE PROCESS

Monomers of the lowest molecular weight are desirable for holographically generating porous polymers because of their relatively low material expense, viscosities and they are readily evaporated. Some representative materials that have been photopolymerized with Irgacure 369 from Ciba-Geigy are described below.

TABLE 1
Low molecular weight monomers [15] suitable for
holographically fabricating porous polymers.

| Monomer Name: | Monomer: | Polymer: |
|---|---|---|
| ethylene | CH₂═CH₂ | 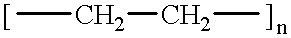 |
| isobutylene | 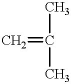 | 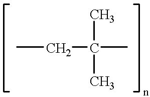 |
| acrylonitrile | CH₂═CH—CN | 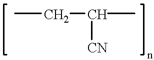 |
| vinyl chloride | CH₂═CN—Cl | 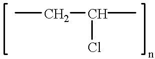 |

### EXAMPLE 3: POSITIVE PROCESS

Any of a large number of positive photoresists described in Moreau's text, Semiconductor Lithography, Principles, Practices, and Materials suitable candidate materials. The classic example is the positive resist based on diazoquinones and novolak resins. One example is a photoactive diazoquinone ester and a phenolic nonvolak resin. In positive photoresists, illumination breaks down the polymer to monomer units, improving the solubility in these regions. The advantages of positive resists over negative resists for high resolution imaging (≦1 μm) are discussed at length in chapter 2 of Moreau's text. A few advantages include the reduction of resist swelling during development and the absence of oxygen inhibition. However, positive resists typically have lower photospeeds (75 mJ cm⁻²) compared to negative resists.

Although only a few embodiments have been described in detail above, those having ordinary skill in the art will certainly understand that many modifications are possible in the preferred embodiment without departing from the teachings thereof.

All such modifications are intended to be encompassed within the following claims. For example, all positive and negative processes could be interchanged according to the present invention. Other applications of these techniques are also contemplated herein.

What is claimed is:

1. A method comprising:
forming a hologram;
using said hologram to illuminate a photosensitive media, over an entire desired width of a photosensitive media; and
forming features in the photosensitive media over the entire desired width, based on the illumination with the hologram.

2. A method as in claim 1, wherein said photosensitive media is a polymer material.

3. A method as in claim 2, wherein said features include pores in the material.

4. A method as in claim 2, wherein said polymer material is a liquid photopolymer that is cross-linked by specified radiation in said hologram.

5. A method as in claim 1, wherein said using comprises causing a plurality of optical beams to interfere in a holographic matter.

6. A method as in claim 5, wherein said using comprises causing said beams to interfere in the way that causes a standing interference pattern.

7. A method as in claim 1, wherein said features include holes, and said holes are formed to form a porous polymer material.

8. A method as in claim 7, wherein said holes are substantially 100 microns in diameter, and are formed at a period of 200 microns.

9. A method as in claim 5, wherein said causing comprises using a Fourier synthesis to form an inter periods pattern from a sum of signee so it'll gratings.

10. A method as in claim 9, wherein said signee so little gratings form a holes of a specified shape.

11. A method as in claim 10 wherein said specified shape is a prolate ellipsoid.

12. A method as in claim 1, wherein said forming features uses a positive process in which incoming radiation is used to queue or a liquid photopolymer.

13. A method as in claim 1, wherein said forming features uses a negative process in which incoming radiation is used to break certain bonds in an already formed polymer.

14. A method comprising:
using radiation standing waves to form an interference pattern that has a gaussian profile, and hence is substantially constant across an entire depth of interest in a photosensitive media;
exposing a photopolymer to said radiation standing waves; and
further processing said photopolymer to form pores at the locations of the exposing.

15. A method as in claim 14, wherein said exposing of said photopolymer cures a liquid polymer.

16. A method as in claim 14, wherein said exposing of said photopolymer affects structural integrity of a solid polymer.

17. A method as in claim 14, wherein said radiation standing waves have a specified periodicity.

18. A method as in claim 14, wherein said radiation standing waves are interference pattern's formed by interfering claim waves.

19. A method of forming a porous polymer, comprising:
obtaining polymer material;
using an interference pattern to expose the photopolymer material to a periodic standing waves pattern over an entire depth of the photopolymer; and
removing areas of said photopolymer material based on exposure by said interference pattern.

20. A method as in claim 19, wherein said interference pattern has a spatial resolution of less than 100 nm.

21. A method as in claim 19, wherein said removing comprises a positive process in which the incoming radiation is used to queue or parts of the photopolymer.

22. A method as in claim 19, wherein said removing comprises the negative process in which the incoming radiation is used to remove parts of an existing photopolymer.
